(19) United States
(12) Patent Application Publication
(10) Pub. No.: US 2026/0061449 A1
(43) Pub. Date: Mar. 5, 2026

(54) WATER OUTLET DEVICE

(71) Applicant: Xiamen Water Nymph Sanitary Technology Co.,Ltd., Xiamen (CN)

(72) Inventors: Huaqiang ZHOU, Xiamen (CN); Zhiwei ZHUO, Xiamen (CN)

(73) Assignee: Xiamen Water Nymph Sanitary Technology Co.,Ltd., Xiamen (CN)

(21) Appl. No.: 19/384,985

(22) Filed: Nov. 10, 2025

Related U.S. Application Data
(63) Continuation of application No. PCT/CN2023/134679, filed on Nov. 28, 2023.

(30) Foreign Application Priority Data
May 12, 2023 (CN) 202310537812.9

(51) Int. Cl. B05B 15/65; B05B 15/50

(52) U.S. Cl. CPC B05B 15/65; B05B 15/50

(57) ABSTRACT

The disclosure discloses a water outlet device, including a water outlet body and a water outlet panel relatively rotatably connected to the water outlet body; where the water outlet body has a water outlet chamber, where a diameter of a water outlet of the water outlet chamber is less than a maximum diameter of the water outlet panel, where at least one of the water outlet and the water outlet panel is deformable. The disclosure can implement quick disassembly and assembly of the water outlet panel, thereby reducing difficulty of cleaning a water outlet mesh.

### CROSS-REFERENCE TO RELATED APPLICATIONS

This application is a continuation application of International Application No PCTCN2023134679 filed on November 28, 2023, which claims priority to Chinese Application No 2023105378129 filed on May 12, 2023. The disclosures of the above-mentioned applications are hereby incorporated by reference in their entireties.

### TECHNICAL FIELD

The disclosure relates to the field of sanitary ware and in particular to a water outlet device.

### BACKGROUND

To change a water outlet state, an existing sanitary product such as a multi-functional aerator or a shower head, changes a connected relation of a water channel generally by adopting a rotation adjustment or pressing adjustment manner, thereby producing different forms of water outlet sprays.

A water outlet mesh is usually provided at a water outlet end of the foregoing product to shape a water flow, thereby producing different water outlet sprays. However, after being used for a long time, the water outlet mesh is prone to being adhered with water scale or being clogged with impurities, resulting in unsmooth water outgoing of the sanitary product or deformation of sprays. To solve the foregoing technical problems, it is usually needed to disassemble the sanitary product, and to clean the water outlet mesh by using detergent and other cleaning tools. However, the existing multi-functional sanitary products are generally more complex in structure and difficult in disassembly or installation, which makes it difficult for a user to clean the water outlet mesh in daily use.

### SUMMARY

The disclosure relates to a water outlet device, including a water outlet body and a water outlet panel relatively rotatably connected to the water outlet body, where the water outlet body has a water outlet chamber, the water outlet chamber has a water outlet, a diameter of the water outlet is less than a maximum diameter of the water outlet panel, and at least one of the water outlet and the water outlet panel is deformable such that the water outlet panel can be fitted into or detached from the water outlet.

### BRIEF DESCRIPTION OF THE DRAWINGS

FIG. 1 is an exploded view of a water outlet device according to some embodiments of the disclosure.

FIG. 2 is a schematic structural diagram in a case where a water outlet panel and a water outlet body of a water outlet device are coaxially disposed according to some embodiments of the disclosure.

FIG. 3 is a sectional view in a case where a water outlet panel and a water outlet body of a water outlet device are coaxially disposed according to some embodiments of the disclosure.

FIG. 4 is a schematic structural diagram in a case where a water outlet panel and a water outlet body of a water outlet device are non-coaxially disposed according to some embodiments of the disclosure.

FIG. 5 is a sectional view I in a case where a water outlet panel and a water outlet body of a water outlet device are non-coaxially disposed according to some embodiments of the disclosure.

FIG. 6 is a sectional view II in a case where a water outlet panel and a water outlet body of a water outlet device are non-coaxially disposed according to some embodiments of the disclosure.

FIG. 7 is a bottom view of FIG. 4.

### DETAILED DESCRIPTION OF THE EMBODIMENTS

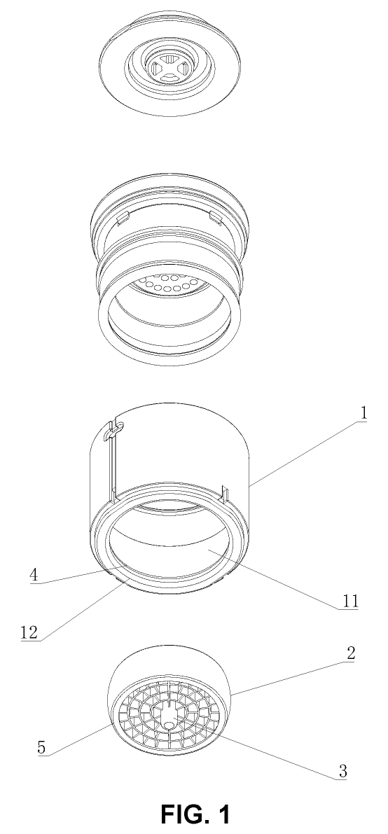

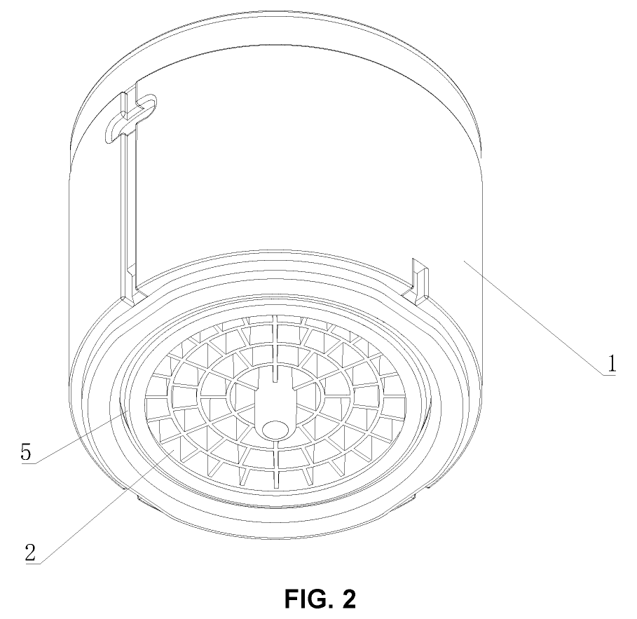

With reference to FIGS. 1 to 7, a water outlet device includes a water outlet body 1 and a water outlet panel 2 relatively rotatably connected to the water outlet body 1. The water outlet panel 2 mainly plays a role in filtering and rectifying a water flow. In the disclosure, the water outlet panel 2 not only can rotate relative to the water outlet body 1, but also can be rotated relative to the water outlet body 1. The water outlet body 1 has a water outlet chamber 11. The water outlet chamber 11 has a water outlet 12. A diameter of the water outlet 12 is less than a maximum diameter of the water outlet panel 2. When the water outlet panel 2 is engaged with or disengaged from the water outlet 12, at least one of the water outlet 12 and the water outlet panel 2 is deformable. A deformation occurring when the water outlet panel 2 is disengaged from or engaged with the water outlet 12 may be a deformation of an inward depression occurring on a sidewall of the water outlet panel 2 or a deformation of an outward expansion occurring at the water outlet 12 of the water outlet body 1. The deformation occurring at the water outlet 12 of the water outlet body 1 is an optimal selection. When a deformed object is the water outlet 12 of the water outlet body 1, the water outlet panel 2 may be selectively made of a material which is higher rigidity and is not prone to deformation. If the deformed object is the water outlet panel 2 and the water outlet panel 2 is made of a rigid material, an elastic material is to be sleeved on a circumferential sidewall of the water outlet panel 2. The elastic material specifically may be silicone rubber or rubber. If both the water outlet panel 2 and the water outlet body 1 are made of elastic materials, the deformation may occur at both the water outlet panel 2 and the water outlet body 1 during a disengagement or engagement process. The only difference is that the one with relatively high rigidity and greater structural wall thickness undergoes a lower degree of deformation, while the other one with relatively low rigidity and smaller structural wall thickness undergoes a higher degree of deformation. The degree of deformation may vary depending on the actual use of parts.

It may be understood that, to enable the water outlet panel 2 to keep a relatively stable positional relation with the water outlet body 1 when the water outlet panel 2 is assembled in the water outlet body 1, setting the diameter of the water outlet 12 to be less than the maximum diameter of the water outlet panel 2 ensures that the water outlet panel 2 under the impact of a water flow can be always disposed in a clamped manner in the water outlet 12. A maximum pressure that can be withstood at a clamping point may be designed depending on actual water use conditions. The greater the diameter difference between the diameter of the water outlet 12 and the maximum diameter of the water outlet panel 2, the higher the water pressure that can be withstood. On the contrary, the smaller the diameter difference between the diameter of the water outlet 12 and the maximum diameter of the water outlet panel 2, the lower the water pressure that can be withstood. The deformation can occur between the water outlet panel 2 and the water outlet body 1, and then the water outlet panel 2 can be separated from the water outlet body 1 at the water outlet 12, for quick cleaning of the water outlet panel 2. In addition, after the cleaning of the water outlet panel 2 is completed, the water outlet panel 2 can be quickly assembled back into the water outlet device due to the deformation occurring between the water outlet panel 2 and the water outlet 12, so that quick assembly and disassembly of the water outlet panel 2 are implemented. Compared with the prior art, integral disassembly and assembly are not needed, and the water outlet panel 2 only needs to be pulled out from or fitted into the water outlet body 1, so that the difficulty of cleaning the water outlet panel 2 is greatly reduced.

In some embodiments, when the water outlet panel 2 is fitted in the water outlet chamber 11 and completely covers the water outlet 12, a sidewall of the water outlet panel 2 is in line contact or surface contact with an inner wall of the water outlet chamber 11, and an inner diameter of the water outlet chamber 11 at a position in contact with the water outlet panel 2 is less than or equal to the maximum diameter of the water outlet panel 2. In this state, the sidewall of the water outlet panel 2 is in surface contact or line contact with the inner wall of the water outlet chamber 11, and especially when the sidewall of the water outlet panel 2 is in line contact with the inner wall of the water outlet chamber 11, the rotation smoothness between the water outlet panel 2 and the water outlet chamber 11 can be ensured.

In some embodiments, a sealing ring 4 is fitted in an inner wall of the water outlet chamber 11 that is close to the water outlet 12. A circumferential sidewall of the water outlet panel 2 is pressed against the sealing ring 4. To keep the water outlet panel 2 pressed against the sealing ring 4, the sealing ring 4 is to protrude on the inner wall of the water outlet chamber 11. Specifically, the water outlet panel 2 is in contact or point contact with the sealing ring 4.

After the water outlet panel 2 is fitted in the water outlet 12, contact between the water outlet panel 2 and the water outlet body 1 mainly relies on the sealing ring 4. The disposing of the sealing ring 4 on one hand is to ensure sealing between the water outlet panel 2 and the inner wall of the water outlet chamber 11, and on the other hand is to provide radial support for the water outlet panel 2 and serve as a rotation fulcrum of the water outlet panel 2, so as to ensure that the water outlet panel 2 remains stable when fitted in the water outlet chamber 11. However, the water outlet panel 2, when pressed by an external force in a water incoming direction, may make contact with an inner-side sidewall of the water outlet chamber 11, and a reverse force is applied on the water outlet panel 2 by the sidewall of the water outlet chamber 11, so that a position where the water outlet panel 2 is connected to the sealing ring 4 is maintained. The water outlet panel 2, when subjected to a water pressure action in a water outgoing direction, may make contact with a sidewall at the water outlet 12, and a reverse force is applied on the water outlet panel 2 by the circumferential sidewall at the water outlet 12 of which the diameter is less than the diameter of the water outlet panel 2, so that the position where the water outlet panel 2 is connected to the sealing ring 4 can be also maintained.

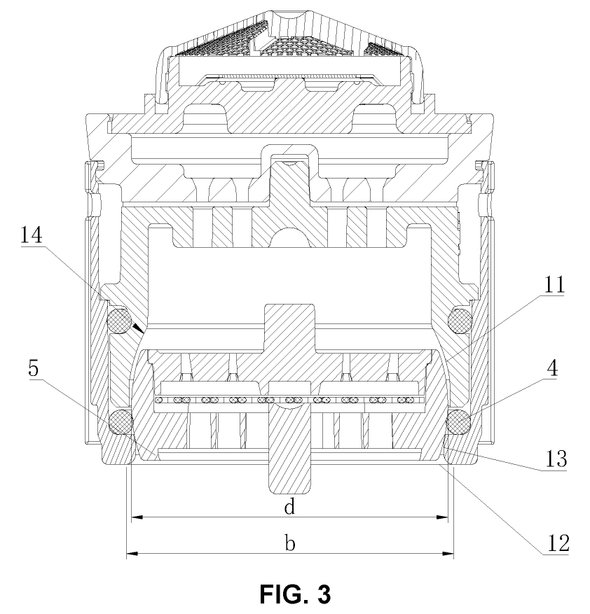

In some embodiments, an outer wall of the water outlet panel 2 and an inner wall of the water outlet chamber 11 are spherical surfaces or polygonal prism surfaces. The spherical surfaces include complete spherical surfaces and incomplete spherical surfaces. With reference to FIGS. 3, 5 and 6, when the circumferential sidewall of the water outlet panel 2 is a complete spherical surface, in an axial sectional view of the water outlet panel 2, the circumferential sidewall of the water outlet panel 2 is an arc line and distances between points on the arc and a stereoscopic center point of the water outlet panel 2 are equal. The incomplete spherical surface refers to that in the axial sectional view of the water outlet panel 2, a circumferential sidewall profile of the water outlet panel 2 is an arc line or a combination of an arc line and a straight line, and radiuses of points on the arc line and a stereoscopic center point of the water outlet panel are not all equal. However, the polygonal prism surface refers to that in the axial sectional view of the water outlet panel, the circumferential sidewall profile of the water outlet panel 2 is a combination of a plurality of straight lines. Correspondingly, the water outlet chamber 11 is one of a complete spherical surface, an incomplete spherical surface, or a polygonal prism surface, and the water outlet chamber being the complete spherical surface is an optimal selection. To enable the water outlet panel 2 to rotate smoothly in the water outlet chamber 11, the circumferential sidewall of the water outlet panel 2 is completely spherical, and correspondingly, the water outlet chamber 11 is also completely spherical. However, the difference is that the water outlet panel 2 and the inner wall of the water outlet chamber 11 vary in dimensions. Specifically, to enable the water outlet panel 2 to withstand an impact of the water flow and always to be pressed against the sealing ring 4 when the water outlet panel 2 is fitted in the water outlet chamber 11, in some embodiments, when an axis of the water outlet panel 2 is perpendicular to an axis of the water outlet 12, the axis of the water outlet panel 2 is located on one side of the sealing ring 4 that is away from the water outlet 12, so that a maximum diameter d of the water outlet panel 2 is always located on one side of the water outlet chamber 11 that is away from the water outlet 12.

In some embodiments, an inner diameter of the sealing ring 4 at a position in contact with the water outlet panel 2 is less than the maximum diameter of the water outlet panel 2. Similarly, this condition is limited to cause the maximum diameter d of the water outlet panel 2 to be always located on one side of the water outlet chamber 11 that is away from the water outlet 12, so that the water outlet panel 2 can remain stable when impacted by a water flow, and is not disengaged from the water outlet chamber 11.

In some embodiments, when the water outlet panel 2 is rotated to be coaxial with the water outlet chamber 11, a position where the water outlet panel 2 is in contact with the sealing ring 4 is located on one side of the maximum diameter d of the water outlet panel 2 that is close to the water outlet 12. This condition is likewise limited to cause the water outlet panel 2 to remain stable when impacted by the water flow, and further improve stability of the water outlet panel 2, so that the water outlet panel 2, no matter how rotated and flipped at any angle relative to the water outlet 12, can always keep connected to the water outlet 12 when only subjected to a conventional water pressure action.

In some embodiments, one end of the water outlet chamber 11 that is close to the water outlet 12 has a neck 13, where a diameter k of the neck 13 is less than the maximum diameter d of the water outlet panel 2.

In some embodiments, a ratio of the diameter k of the neck 13 to the maximum diameter d of the water outlet panel 2 is 0.97 to 0.99. Optionally, a difference between the diameter k of the neck 13 and the maximum diameter d of the water outlet panel 2 is 0.1 mm to 1 mm. In some embodiments, the difference is 0.2 mm to 0.8 mm. Preferably, the difference may be 0.25 mm, 0.3 mm, 0.4 mm, 0.5 mm, 0.6 mm, 0.7 mm, or 0.75 mm. Specifically, in some embodiments, the maximum diameter d of the water outlet panel 2 is 12 mm to 30 mm.

When the diameter of the neck 13 is too small, the water outlet panel 2 is subject to excessive resistance when separated from the water outlet body 1, which makes disassembly more difficult. When the diameter of the neck 13 is too large, the water outlet panel 2 is prone to falling off from the water outlet 12 after impacted by the water flow. Therefore, setting a ratio of the diameter of the neck 13 to the diameter of the water outlet panel 2, as well as a difference between the diameters within the foregoing value range can be used to play a role in limiting the water outlet panel 2 when the water outlet panel 2 is impacted by the water flow, so that the water outlet panel 2 is not washed away from the water outlet chamber 11 by water, while it can ensure that the water outlet panel 2 has a good feel for disassembly when disassembled.

In some embodiments, a friction enhancement portion 5 is provided on at least one surface of the water outlet panel 2 in an axial direction of the water outlet panel 2. Optionally, a friction enhancement portion 5 is provided on one surface or two surfaces of the water outlet panel 2 in an axial direction of the water outlet panel 2. Specifically, the friction enhancement portion 5 may be a convex lip provided around a face peripheral edge of the water outlet panel 2 or protrusions provided at intervals around

the face peripheral edge of the water outlet panel 2, or a water outlet mesh having a larger friction force may be also provided on a face of the water outlet panel 2.

In some embodiments, a ratio of an axial thickness of the water outlet panel 2 to the diameter of the water outlet 12 is 0.1 to 0.7. Optionally, the proportion range is 0.167 to 0.5, where the proportion may be 0.2, 0.25, 0.26, 0.27, 0.28, 0.29, 0.3, 0.31, 0.32, 0.33, 0.34, 0.35, 0.36, 0.37, 0.4, or 0.45. If the thickness of the water outlet panel 2 is too large, when the axis of the water outlet panel 2 is perpendicular to the axis of the water outlet 12, a spacing between the water outlet panel 2 and the water outlet 12 will be too small for a user to directly insert their fingers into the gap 15 formed between the water outlet panel 2 and the water outlet 12 to pull out the water outlet panel 2. Therefore, separation between the water outlet panel 2 and the water outlet body 1 becomes more difficult, and a disassembly operation can only be implemented with the help of a tool, for example, a needle-nose plier or the like. If the thickness of the water outlet panel 2 is too small, it will cause a contact area between the water outlet panel 2 and the sealing ring 4 to be too small, such that the water outlet panel 2 exhibits poor stability when subjected to water flow impact, making it unable to maintain a coaxial state with the water outlet body 1. Therefore, the axial thickness of the water outlet panel 2 and the diameter of the water outlet 12 are limited within the value range, so that the water outlet panel 2 not only can be pulled out easily but also can remain stable relatively to the water outlet body 1 when impacted by the water flow.

In some embodiments, when the axis of the water outlet panel 2 is perpendicular to the axis of the water outlet 12, a maximum spacing between the water outlet panel and the water outlet 12 is 4 mm to 15 mm. Optionally, the maximum spacing between the water outlet panel and the water outlet 12 is 5 mm, 6 mm, 7 mm, 8 mm, 9 mm, 10 mm, 11 mm, 12 mm, 13 mm, or 14 mm. Preferably, the maximum spacing is 5.75 mm.

In some embodiments, referring to FIGS. 1 to 7, a water outlet device includes a water outlet body 1 and a water outlet panel 2 relatively rotatably connected to the water outlet body 1. The water outlet body 1 has a water outlet chamber 11, and the water outlet chamber 11 has a water outlet 12. A diameter b of the water outlet 12 is less than a maximum diameter d of the water outlet panel 2. During a process in which the water outlet panel 2 is engaged with or disengaged from the water outlet 12, a deformation can occur between the water outlet 12 and the water outlet panel 2. Preferably, a sealing ring 4 is fitted in an inner wall of the water outlet chamber 11 that is close to the water outlet 12, and a circumferential sidewall of the water outlet panel 2 is

pressed against the sealing ring 4. Therefore, the water outlet panel 2 is actually located in the water outlet chamber 11, and when the water outlet panel 2 is not pressed by an external force or impacted by a water pressure, the sealing ring 4 always keeps in contact with the water outlet panel 2. An inner diameter of the sealing ring 4 at a position in contact with the water outlet panel 2 is less than a maximum diameter of the water outlet panel 2, and the sealing ring 4 is pressed against the water outlet panel 2 in a line contact manner. To reduce difficulty of flipping the water outlet panel 2, rotation rods 3 are respectively provided in end faces of both sides of the water outlet panel 2 axially, and an axial length of the rotation rod 3 is not greater than a maximum radius of the water outlet panel 2. However, when the water outlet panel 2 is pressed by an external force or impacted by a water flow, the water outlet panel 2 makes contact with an inner wall of the water outlet chamber 11. The inner wall of the water outlet chamber 11 makes line contact or surface contact with a sidewall of the water outlet panel 2 so as to support and limit the water outlet panel 2, so that the water outlet panel 2 is always located in the water outlet chamber 11.

In some embodiments, the water outlet chamber 11 is elastic, while the water outlet panel 2 is made of a rigid material, such that the water outlet 12 can deform to allow the water outlet panel 2 to be fitted into or detached from the water outlet 12. In other equivalent embodiments, both the water outlet chamber 11 and the water outlet panel 2 are made of rigid materials. In this case, an elastic sleeve needs to be additionally provided on the circumferential sidewall of the water outlet panel 2 as part of the sidewall of the water outlet panel 2. The elastic sleeve is made of silicone rubber or rubber, such that the elastic sleeve can deform to allow the water outlet panel 2 to be fitted into or detached from the water outlet 12. In other equivalent embodiments, the water outlet chamber 11 is made of a rigid material, while the entire water outlet panel 2 is made of silicone rubber or rubber with higher hardness, such that the water outlet panel 2 can deform to be fitted into or detached from the water outlet 12.

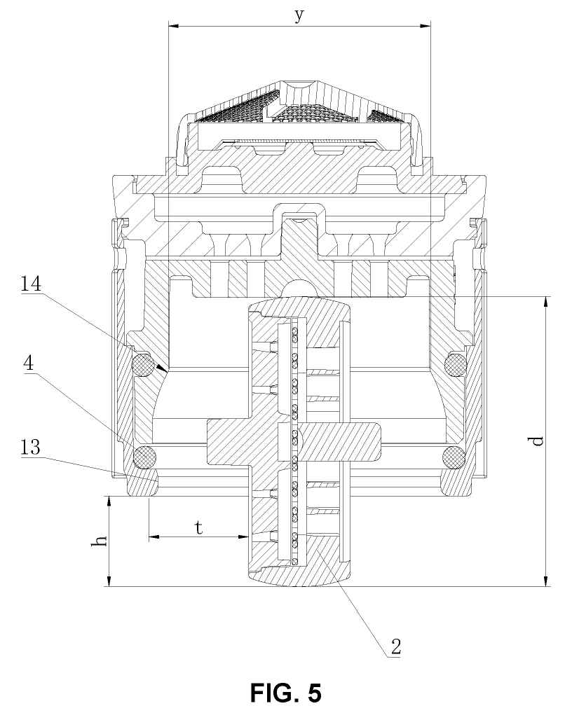

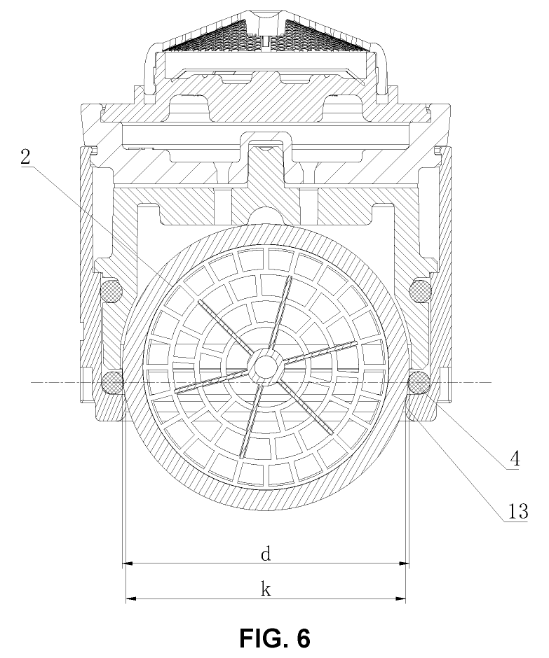

In some embodiments, referring to FIGS. 5 and 6, when an axis of the water outlet panel 2 is perpendicular to an axis of the water outlet 12, the axis of the water outlet panel 2 is located on one side of the sealing ring 4 that is away from the water outlet 12. When the water outlet panel 2 is rotated to be coaxial with the water outlet chamber 11, a position where the water outlet panel 2 is in contact with the sealing ring 4 is located on one side of a maximum diameter d of the water outlet panel 2 that is close to the water outlet 12.

In some embodiments, with reference to FIGS. 5 and 6, one end of the water outlet chamber 11 that is close to the water outlet 12 has a neck 13, where a diameter k of the neck 13 is less than the maximum diameter d of the water outlet panel 2, and the diameter k of the neck 13 is less than the diameter of the water outlet 12. However, to implement that a position where the water outlet panel 2 is connected to the sealing ring 4 is maintained after the water outlet panel 2 is pressed, one end of the water outlet chamber 11 that is away from the water outlet 12 has a limiting portion 14, where an inner diameter y of the limiting portion 14 is less than the maximum diameter d of the water outlet panel 2. After the water outlet panel 2 is pressed, one end of the water outlet panel 2 that is away from the water outlet 12 is pressed against the limiting portion 14.

In some embodiments, with reference to FIG. 6, a ratio of the diameter k of the neck 13 to the maximum diameter d of the water outlet panel 2 is 0.96 to 0.99. Further, a difference between the maximum diameter d of the water outlet panel 2 and the diameter k of the neck 13 is 0.3 mm to 0.8 mm. Preferably, the difference between the maximum diameter d of the water outlet panel 2 and the diameter k of the neck 13 is 0.4 mm. In this embodiment, the maximum diameter d of the water outlet panel 2 is 12 mm to 30 mm.

In some embodiments, with reference to FIGS. 1 to 3, friction enhancement portions 5 are provided on two surfaces of the water outlet panel 2 in an axial direction of the water outlet panel 2. Specifically, the friction enhancement portion 5 is an annular convex lip, where circumferential thicknesses of the friction enhancement portions 5 located on two surfaces of the water outlet panel 2 may be the same or different. In this embodiment, the two friction enhancement portions 5 of the water outlet panel 2 are of different thicknesses. The axial thickness of the friction enhancement portion 5 is 0.1 mm to 1 mm. Preferably, the axial thickness of the friction enhancement portion 5 is 0.3 mm, 0.4 mm, 0.5 mm, or 0.6 mm.

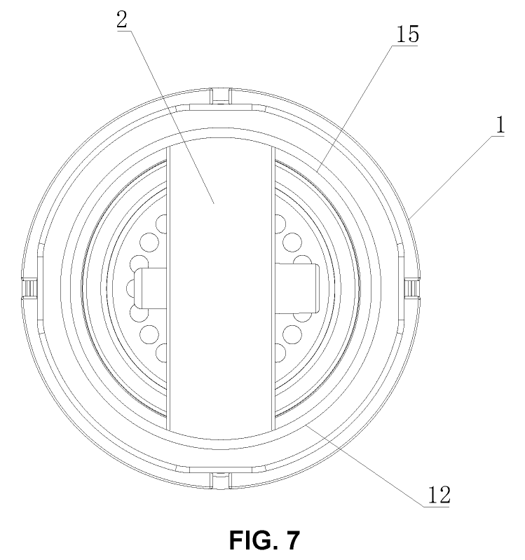

In some embodiments, the ratio of the axial thickness of the water outlet panel 2 to the diameter of the water outlet 12 is 0.344. Further, with reference to FIG. 5 and FIG. 6, when the axis of the water outlet panel 2 is perpendicular to the axis of the water outlet 12, a maximum spacing t between the water outlet panel 2 and the water outlet 12 is 4 mm to 15 mm. The maximum spacing t between the water outlet panel 2 and the water outlet 12 refers to, in the foregoing state, with reference to FIG. 7, in a projection area in an axial direction of the water outlet 12, a maximum distance, in a radial direction of the water outlet 12, of a gap 15 formed between the water outlet panel 2 and the inner wall of the water outlet 12.

The working principle of some embodiments of the disclosure are as follows.

When the water outlet device is in a working state, the water outlet panel 2 and the water outlet body 1 are basically coaxial. The axes of the water outlet panel 2 and the water outlet body 1 may also maintain a specific angle (for example, an angle between the axes of the water outlet panel 2 and the water outlet body 1 is less than 15 degrees). As such, a water flow output from the water outlet panel 2 generates a specific angle relative to a water incoming direction, where the angle is consistent with the angle between the axes of the water outlet panel 2 and the water outlet body 1.

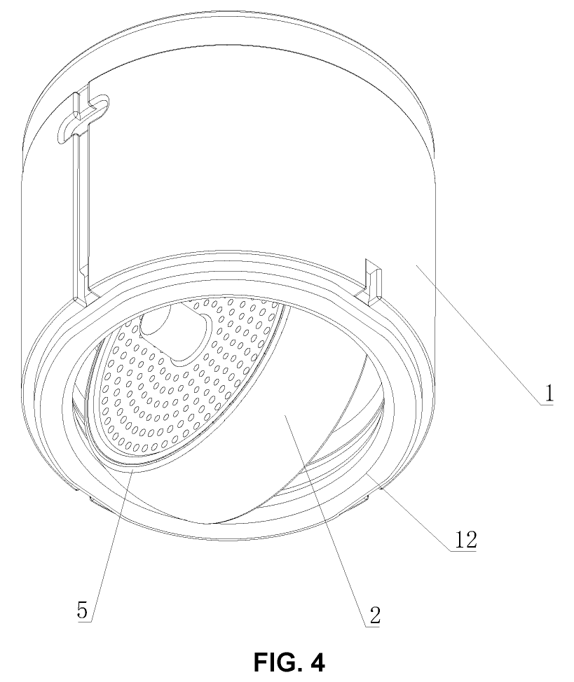

With reference to FIGS. 4 to 6, when the water outlet panel 2 needs to be disassembled for cleaning, the water outlet panel 2 is rotated, so that the axis of the water outlet panel 2 is perpendicular or approximately perpendicular to the axis of the water outlet 12. At this point, the circumferential sidewall of the water outlet panel 2 is in point contact with the sealing ring 4, where a friction force between the circumferential sidewall of the water outlet panel 2 and the sealing ring 4 is minimum, and two water outgoing end faces of the water outlet panel 2 may be pinched with bare hands to be pulled out toward the water outgoing direction of the water outlet device. In a process of pulling out, the water outlet panel 2 slightly expands the water outlet 12 (that is, the water outlet 12 is deformed), and a slight depression is also generated on a sidewall of the water outlet panel 2. After the water outlet panel 2 is completely pulled out from the water outlet 12, the disassembly is completed. The water scale and other impurities of the disassembled water outlet panel 2 may be cleared out in a physical or chemical cleaning manner. For the physical cleaning, mesh openings of the water outlet panel 2 are brushed with the help of a cleaning tool, so as to clear out soft water scale on water outlet holes of the water outlet panel 2 and other impurities that clog the mesh openings. For the chemical cleaning, the water outlet panel 2 may be soaked with an acid detergent, so as to clear out hard water scale on water outlet holes of the water outlet panel 2 or on an internal water path of the water outlet panel.

After cleaning, the water outlet panel 2 and the water outlet 12 may be coaxially disposed (at this point, the friction force between the water outlet panel 2 and the water outlet 12 is maximum), or after the axis of the water outlet panel 2 is perpendicular to the axis of the water outlet 12 (at this point, the friction force between the water outlet panel 2 and the water outlet 12 is minimum), the water outlet panel 2 is then pressed, from the water outlet 12, into the water outlet chamber 11 and keeps engaged with the water outlet 11, so that the assembly is completed.

A difference between other embodiments and above embodiments lies in that, when the water outlet panel 2 is fitted in the water outlet chamber 11, the sidewall of the water outlet panel 2 is in line contact or point contact with the water outlet chamber 11, and the inner diameter of the water outlet chamber 11 at a position in contact with the water outlet panel 2 is less than or equal to the maximum diameter of the water outlet panel 2. Preferably, the inner diameter of the water outlet chamber 11 at a position in contact with the water outlet panel 2 is less than the maximum diameter d of the water outlet panel 2. In some embodiments, the circumferential sidewall of the water outlet panel 2 keeps in contact with the inner wall of the water outlet chamber 11, thereby implementing sealing, so that a water flow flows out from the water outlet panel.

In conclusion, the water outlet device provided by the disclosure plays a role in supporting and sealing the water outlet panel by means of cooperation between the water outlet panel and the sealing ring in the water outlet body, and implements quick disassembly and installation of the water outlet panel by means of elastic cooperation between the water outlet panel and the water outlet body. Settings of the position where the water outlet panel is in contact with the sealing ring and settings of a position between the water outlet panel and the water outlet can keep a relatively stable connection relationship between the water outlet panel and the water outlet body, thereby avoiding disengagement of the water outlet panel from the water outlet body due to an impact of the water flow. Meanwhile, it can be ensured that the water outlet panel can be rapidly separated from the water outlet body and then the difficulty of cleaning the water outlet panel is reduced.

The above are only the embodiments of the disclosure and do not therefore limit the protection scope of the disclosure. Any equivalent transformation made based on the specification and the drawings of the disclosure, which is directly or indirectly applied in other related technical fields, is likewise included within the scope of patent protection of the disclosure.

What is claimed is:

1. A water outlet device, comprising a water outlet body and a water outlet panel relatively rotatably connected to the water outlet body;
wherein the water outlet body has a water outlet chamber, wherein a diameter of a water outlet of the water outlet chamber is less than a maximum diameter of the water outlet panel, and at least one of the water outlet and the water outlet panel is deformable, such that the water outlet panel can be fitted into or detached from the water outlet.

2. The water outlet device according to claim 1, wherein when the water outlet panel is fitted in the water outlet chamber, a sidewall of the water outlet panel is in line contact or surface contact with an inner wall of the water outlet chamber.

3. The water outlet device according to claim 1, wherein an inner diameter of the water outlet chamber at a position in contact with the water outlet panel is less than or equal to the maximum diameter of the water outlet panel.

4. The water outlet device according to claim 2, wherein an inner diameter of the water outlet chamber at a position in contact with the water outlet panel is less than or equal to the maximum diameter of the water outlet panel.

5. The water outlet device according to claim 1, wherein a sealing ring is provided on an inner wall of the water outlet chamber that is close to the water outlet, and a circumferential sidewall of the water outlet panel is pressed against the sealing ring.

6. The water outlet device according to claim 5, wherein when an axis of the water outlet panel is perpendicular to an axis of the water outlet, the axis of the water outlet panel is located on one side of the sealing ring that is away from the water outlet.

7. The water outlet device according to claim 5, wherein an inner diameter of the sealing ring at a position in contact with the water outlet panel is less than the maximum diameter of the water outlet panel.

8. The water outlet device according to claim 7, wherein when the water outlet panel is disposed coaxially with the water outlet chamber, a position where the water outlet panel is in contact with the sealing ring is located on one side of the maximum diameter of the water outlet panel that is close to the water outlet.

9. The water outlet device according to claim 1, wherein one end of the water outlet chamber that is close to the water outlet has a neck, wherein a diameter of the neck is less than the maximum diameter of the water outlet panel.

10. The water outlet device according to claim 9, wherein a ratio of the diameter of the neck to the maximum diameter of the water outlet panel is 0.96 to 0.99.

11. The water outlet device according to claim 9, wherein a difference between the maximum diameter of the water outlet panel and the diameter of the neck is 0.3 mm to 0.8 mm.

12. The water outlet device according to claim 1, wherein a friction enhancement portion is provided on at least one surface of the water outlet panel in an axial direction of the water outlet panel.

13. The water outlet device according to claim 1, wherein a ratio of an axial thickness of the water outlet panel to the diameter of the water outlet is 0.1 to 0.7.

14. The water outlet device according to claim 13, wherein when an axis of the water outlet panel is perpendicular to an axis of the water outlet, a maximum spacing between the water outlet panel and the water outlet is 4 mm to 15 mm.

15. The water outlet device according to claim 1, wherein a circumferential sidewall of the water outlet panel and an inner wall of the water outlet chamber are spherical surfaces or polygonal prism surfaces.
